(19) United States
(12) Patent Application Publication
(10) Pub. No.: US 2015/0288039 A1
(43) Pub. Date: Oct. 8, 2015

(54) BATTERY MODULE

(71) Applicant: SANYO Electric Co., Ltd., Osaka (JP)

(72) Inventors: Shiya Geshi, Osaka (JP); Masatoshi Nagayama, Osaka (JP); Oose Okutani, Hyogo (JP)

(21) Appl. No.: 14/436,876

(22) PCT Filed: Oct. 29, 2013
(86) PCT No.: PCT/JP2013/006372

§ 371 Date: Apr. 18, 2015

(30) Foreign Application Priority Data
Oct. 30, 2012 (JP) 2012-239625

(51) Int. Cl. H01M 10/655

(52) U.S. Cl. CPC H01M 10/655

(57) ABSTRACT

An aspect of battery module includes a plurality of columnar batteries stored in storage unit of a high thermal conductivity. The storage unit includes base section, first frame sections, and second frame sections. The base section is a base member to which the first frame sections and the second frame sections are fixed. The first frame sections are hollow cylindrical members protruding on one main surface side of the base section. The second frame sections are hollow cylindrical members protruding on the other main surface side of the base section. The first frame sections and second frame sections are alternately arranged. A half of each battery is covered with each first frame section or each second frame section.

### TECHNICAL FIELD

The present invention relates to a battery module including a plurality of batteries stored in it.

### BACKGROUND ART

Generally, the electromotive force of a battery (single cell) is low. Even a lithium ion battery considered to have a high electromotive force has an electromotive force of as low as about 4 V. Therefore, when a higher voltage is required, a plurality of batteries are interconnected in series into modules.

For example, Patent Literature 1 discloses a technology of storing a plurality of batteries in an exterior case and disposing a thermal runaway prevention wall (specifically, heat insulation material) between adjacent batteries. Patent Literature 2 discloses a technology of inserting a battery capacitor into a heat radiation block to suppress the temperature increase caused by heat generation during charge/discharge.

### CITATION LIST

### Patent Literature

PTL 1: Unexamined Japanese Patent Publication No. 2007-06673

PTL 2: Japanese Translation of PCT Publication No. 2011-508266

### SUMMARY OF THE INVENTION

Generally, a battery includes a safety valve for gas venting that discharges gas when the gas is generated inside the battery by abnormal heat generation or the like. Regarding a conventional battery module, when gas is discharged by abnormal heat generation from one of the batteries in the battery module, surrounding batteries are heated by the high-temperature gas, and hence the abnormal heat generation of the one battery can sequentially cause abnormal heat generations.

In the technology of Patent Literature 1, sequential thermal runaway of batteries can be suppressed. Due to the installation of a heat insulation material around the batteries, however, heat is apt to be stored in the batteries, the temperature of the batteries increases, and hence the battery performance can reduce. In the technology of Patent Literature 2, the heat radiation property of the batteries is improved. However, measures are not taken against the problem in which, when abnormal heat generation of a battery occurs, the gas generated in the battery sequentially causes abnormal heat generation of the surrounding batteries.

The conventional battery module, thus, can be further improved by compatibly improving the heat radiation property of the batteries and causing abnormal heat generation of the surrounding batteries after abnormal heat generation occurs in one battery.

The present invention addresses such problems. The purpose of the present invention is to provide a technology of improving the heat radiation property of a plurality of batteries stored in a storage unit and yet suppressing sequential abnormal heat generation of the batteries.

An aspect of the present invention is a battery module. The battery module includes a plurality of batteries, and a storage unit that stores the plurality of batteries and is made of a thermally conductive material. The storage unit includes: a plate-like base section; hollow first frame sections that protrude on one main surface side of the base section and into which the batteries can be inserted from the other main surface side of the base section; and hollow second frame sections that are disposed adjacently to the first frame sections and protrude on the other main surface side of the base section, and into which the batteries can be inserted from the one main surface side of the base section. Each battery includes a region covered with each first frame section or each second frame section, and a region exposed to the outside.

In the present invention, the heat radiation property of a plurality of batteries stored in a storage unit is improved, and yet sequential abnormal heat generation of the batteries can be suppressed.

### BRIEF DESCRIPTION OF DRAWINGS

FIG. 1 is a perspective view showing the outward appearance of a battery module in accordance with a first exemplary embodiment.

FIG. 2 is a sectional view of battery 20 incorporated into battery module 10.

FIG. 3 is a perspective view showing the outward appearance of a storage unit included in the battery module in accordance with the first exemplary embodiment.

FIG. 4(A) is a plan view of the storage unit used in the first exemplary embodiment.

FIG. 4(B) is a bottom view of the storage unit used in the first exemplary embodiment.

FIG. 4(C) is a sectional view taken along line A-A of FIG. 4(A).

FIG. 5 is a perspective view showing the outward appearance of a battery module in accordance with a second exemplary embodiment.

FIG. 6(A) is a plan view of a storage unit used in the second exemplary embodiment.

FIG. 6(B) is a bottom view of the storage unit used in the second exemplary embodiment.

FIG. 6(C) is a sectional view taken along line A-A of FIG. 6(A).

### DESCRIPTION OF EMBODIMENTS

Hereinafter, the exemplary embodiments of the present invention will be described with reference to the accompanying drawings. In all drawings, similar elements are denoted with the same reference marks, and the descriptions of those elements are omitted appropriately.

### First Exemplary Embodiment

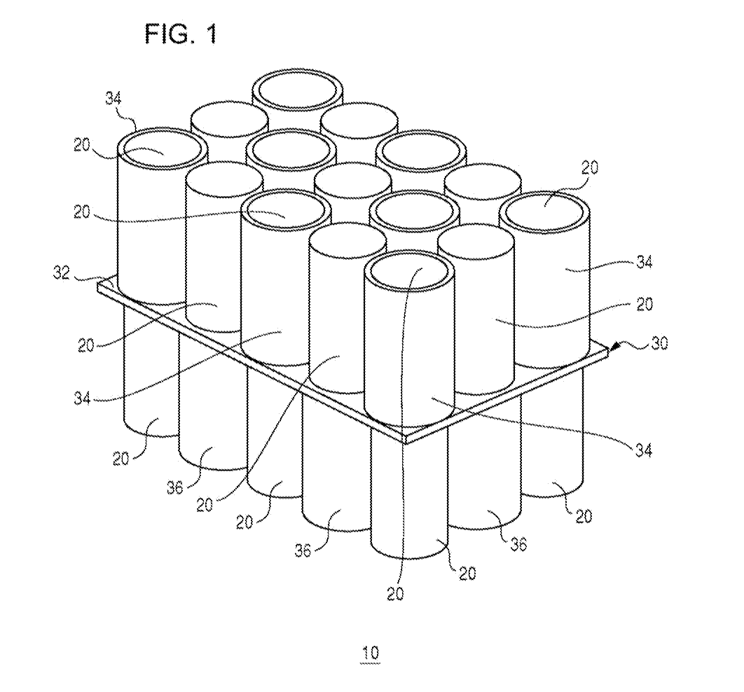

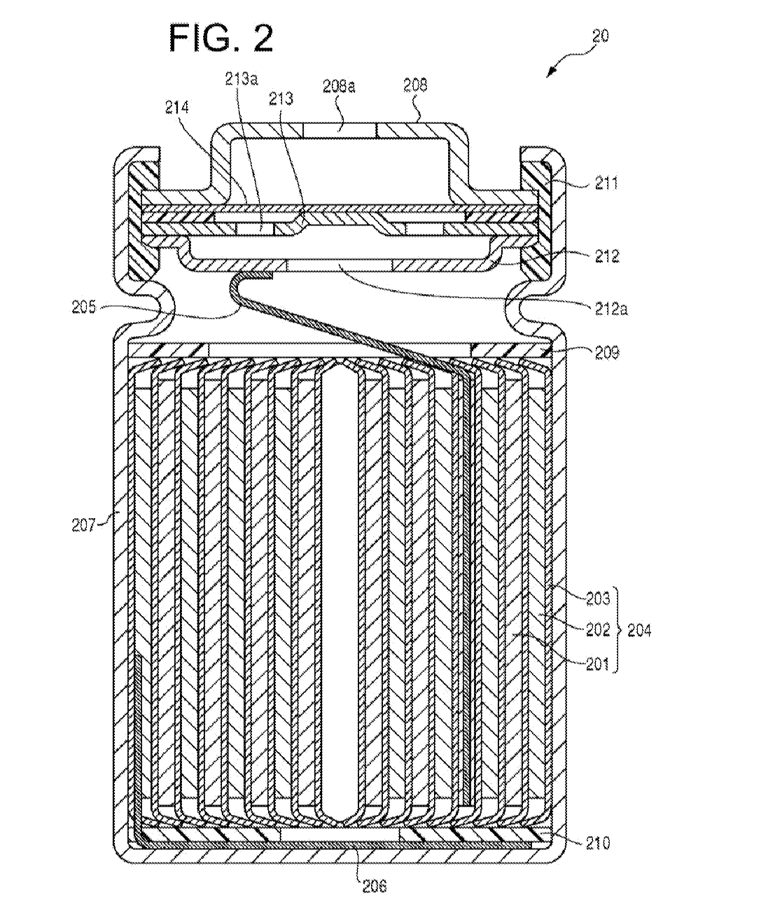

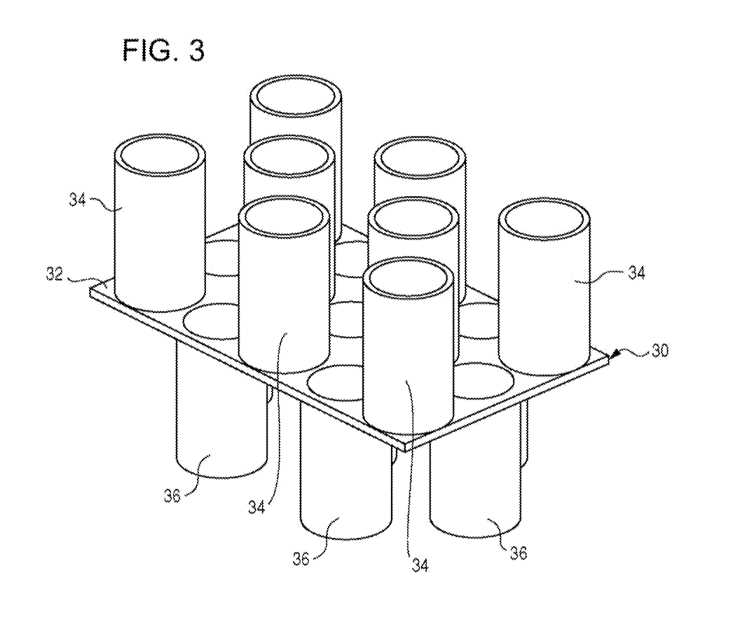

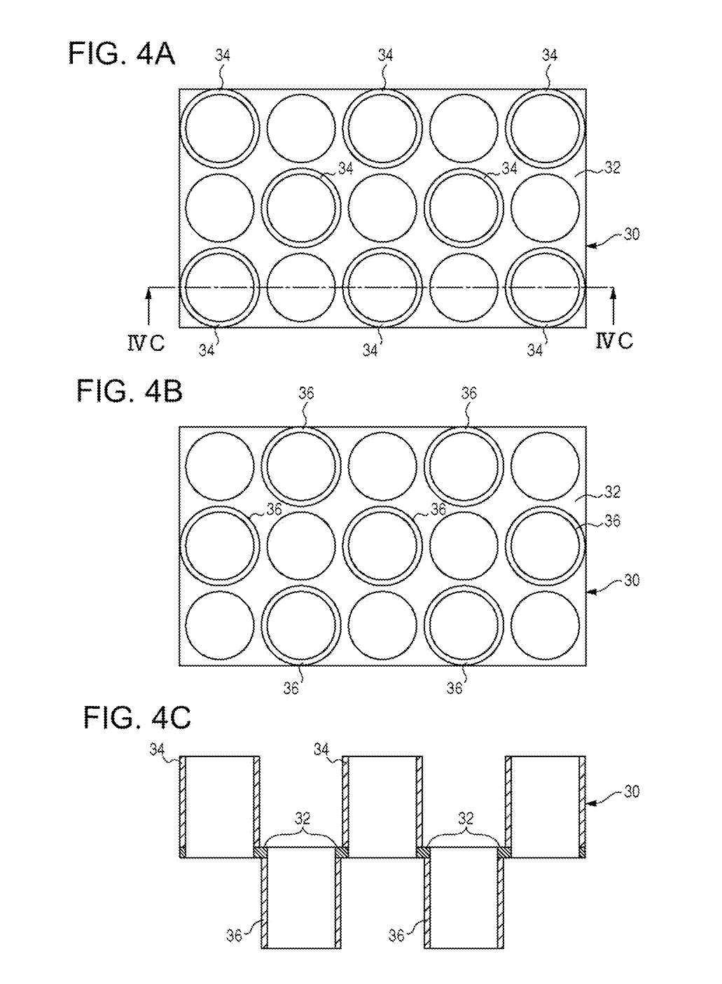

FIG. 1 is a perspective view showing the outward appearance of battery module 10 in accordance with a first exemplary embodiment. FIG. 2 is a sectional view of battery 20 incorporated into battery module 10. FIG. 3 is a perspective view showing the outward appearance of a storage unit included in the battery module in accordance with the first exemplary embodiment. FIG. 4(A) is a plan view of the storage unit used in the first exemplary embodiment. FIG. 4(B) is a bottom view of the storage unit used in the first exemplary embodiment. FIG. 4(C) is a sectional view taken along line A-A of FIG. 4(A).

Battery module 10 includes a plurality of batteries 20 and storage unit 30.

Each battery 20 of the present exemplary embodiment has a columnar outer shape. The outer shape of battery 20 is not limited to this, but may be a rectangular shape, for example. Each battery 20 of the present exemplary embodiment is a lithium ion battery, but may be applied to a nickel hydride battery or a nickel cadmium battery.

Hereinafter, the specific structure of battery 20 is described with reference to FIG. 2. As shown in FIG. 2, electrode group 204 that is formed by winding positive electrode 201 and negative electrode 202 via separator 203 is stored in battery case 207 together with a nonaqueous electrolytic solution (not shown). Insulating plates 209 and 210 are disposed above and below electrode group 204, respectively. Positive electrode 201 is joined to filter 212 via positive electrode lead 205, and negative electrode 202 is joined to the bottom of battery case 207 via negative electrode lead 206. Battery case 207 also serves as a negative electrode terminal.

Filter 212 is connected to inner cap 213, and a projecting part of inner cap 213 is bonded to a metallic valve member 214. Valve member 214 is also connected to terminal plate (electrode part) 218, which also serves as a positive electrode terminal. Terminal plate 218, valve member 214, inner cap 213, and filter 212 integrally seal an opening of battery case 217 via gasket 211.

When the pressure in battery 20 is increased by increase in the temperature of battery 20 or internal short circuit in battery 20, valve member 214 expands toward terminal plate 8 to release the bonding of inner cap 213 to valve member 214. Thus, the current route is blocked. When the pressure in battery 20 is increased, valve member 214 breaks. Thus, the gas generated in battery 20 is discharged to the outside via through hole 212a in filter 12, through hole 213a in inner cap 13, a crack in valve member 214, and opening 208a in terminal plate (electrode part) 2088.

A safety mechanism for discharging, to the outside, the gas generated in battery 20 is not limited to the structure of FIG. 2, but may be another structure.

The structure of storage unit 30 is described with reference to FIG. 3 and FIG. 4(A) to FIG. 4(C). Storage unit 30 has a function of storing a plurality of batteries 20 and a function of radiating heat from batteries 20. Storage unit 30 includes base section 32, first frame sections 34, and second frame sections 36. Hereinafter, first frame sections 34 and second frame sections 36 are sometimes and simply referred to as “frame sections” without distinction. Base section 32, first frame sections 34, and second frame sections 36 are made of a material of a high thermal conductivity, such as aluminum, copper, or magnesium.

Base section 32 is a plate-like member, and serves as a base member to which first frame sections 34 and second frame sections 36 are fixed. In base section 32, openings 33 are formed correspondingly to the installation regions of first frame sections 34 and second frame sections 36. In the present exemplary embodiment, openings 33 are disposed in a grid shape. Since base section 32 has thermal conductivity, heat transfer occurs between first frame sections 34 and second frame sections 36 when temperature variation occurs between them, and the temperature of the frame sections is made uniform.

Each first frame section 34 is a hollow cylindrical member that protrudes on one main surface side of base section 32. Each first frame section 34 is fixed to the rim of each opening 33 disposed in base section 32, and battery 20 can be inserted into each first frame section 34 through each opening 33. First frame sections 34 may be integrated with base section 32 in a seamless manner. Alternatively, each first frame section 34 may be prepared as a member separate from base section 32, and may be fixed to base section 32 by welding or the like.

While, each second frame section 36 is a hollow cylindrical member that protrudes on the other main surface side of base section 32. Each second frame section 36 is fixed to the rim of each opening 33 disposed in base section 32, and battery 20 can be inserted into each second frame section 36 through each opening 33. Second frame sections 36 may be integrated with base section 32 in a seamless manner. Alternatively, each second frame section 36 may be prepared as a member separate from base section 32, and may be fixed to base section 32 by welding or the like.

In the present exemplary embodiment, in the plan view of base section 32 as shown in FIG. 4(A), first frame sections 34 and second frame sections 36 are alternately arranged in a certain line in which frame sections are arranged in the lateral direction of the page having FIG. 4(A). Furthermore, first frame sections 34 and second frame sections 36 are alternately arranged also in a line (the line in the longitudinal direction of the page having FIG. 4(A)) orthogonal to the certain line. In other words, at adjacent grid points, first frame sections 34 and second frame sections 36 are alternately arranged. Therefore, as shown in FIG. 1, in the state where battery 20 is stored in each of first frame sections 34 and second frame sections 36, batteries 20 stored in first frame sections 34 and batteries 20 exposed to the outside are alternately arranged on one side of base section 32.

The axial length of first frame sections 34 and second frame sections 36 is about a half of the axial length of batteries 20. In other words, when batteries 20 are installed in storage unit 30, a half of each battery 20 is covered with first frame section 34 or second frame section 36 and a half of each battery 20 is exposed to the outside. Thus, when a plurality of batteries 20 are stored in storage unit 30, the lower surfaces can be made flush with each other in battery module 10, and the upper surfaces can be made flush with each other. Therefore, a wasted space can be prevented from occurring. Battery module 10 is designed so that the exposed part of each battery 20 does not come into contact with the frame sections covering its adjacent batteries 20. However, battery module 10 may be designed so that, in a stored state of batteries 20 in the frame sections, batteries 20 are in contact with the frame sections, or so that, in a stored state of batteries 20 in the frame sections, clearances occur between batteries 20 and the frame sections. When batteries 20 are in contact with the frame sections, the heat transfer from batteries 20 to the frame sections can be enhanced, and, as a result, the radiation effect of the frame sections can be further enhanced. When clearances are created between batteries 20 and the frame sections, batteries 20 can be easily inserted into the frame sections, and the allowance for some expansion of batteries 20 can suppress the application of stress from the storage unit to batteries 20. Furthermore, since air exists as a heat insulation layer between the frame sections and batteries 20, heat is less apt to transfer from the frame sections to batteries 20. When one of batteries 20 discharges gas by abnormal heat generation, the frame sections not only can block the gas, but also can suppress the transfer of the heat of the gas to surrounding batteries 20. By filling a heat insulation material as a heat insulation layer into the clearances between batteries 20 and the frame sections, the heat transfer from the frame sections to batteries 20 can be suppressed.

Batteries 20 stored in storage unit 30 are electrically interconnected in series or in parallel using an electric connection member (not shown) such as a bus bar.

In above-mentioned battery module 10, about a half of each battery 20 stored in storage unit 30 is covered with first frame section 34 or second frame section 36, and remaining about a half is exposed to the outside. Therefore, the exposed part of each battery 20 directly comes into contact with external air, and hence air cooling is allowed. By disposing a blowing means such as an air cooling fan near battery module 10 and blowing air to batteries 20, batteries 20 can be more effectively cooled. Thus, by improving the heat radiation property of batteries 20, degradation of the active material or electrolytic solution of batteries 20 can be suppressed, and the battery performance can be improved and the service life can be extended.

In above-mentioned battery module 10, even when abnormal heat generation occurs in a specific battery and high-temperature gas leaks from the exposed part of the battery (the part is not covered with the frame section)—specifically, above-mentioned opening 218a—, the gas from the gas leaking part is prevented from directly coming into contact with the adjacent batteries. That is because the batteries adjacent to the exposed part of the specific battery are covered with the frame sections. As a result, when abnormal heat generation occurs in the specific battery, induction of abnormal heat generation in the surrounding batteries can be suppressed.

Thus, in above-mentioned battery module 10, the heat radiation property of a plurality of batteries 20 stored in storage unit 30 is improved, and yet sequential abnormal heat generation of the batteries can be suppressed.

In the present exemplary embodiment, first frame sections 34 and second frame sections 36 are alternately arranged in a certain line of the frame sections and in the line orthogonal to the certain line. However, when first frame sections 34 and second frame sections 36 are alternately arranged in one of the lines, the above-mentioned effect of suppressing sequential abnormal heat generation of the batteries can be produced in at least the one line.

### Second Exemplary Embodiment

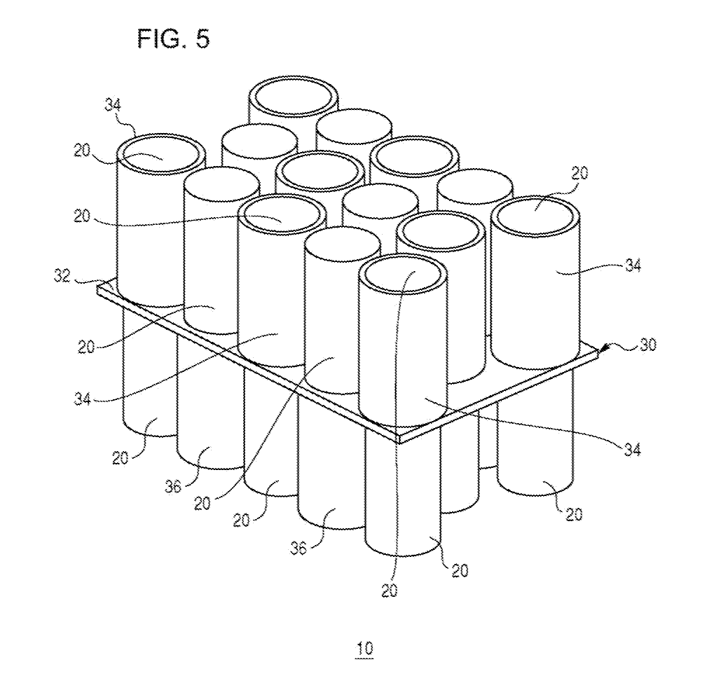

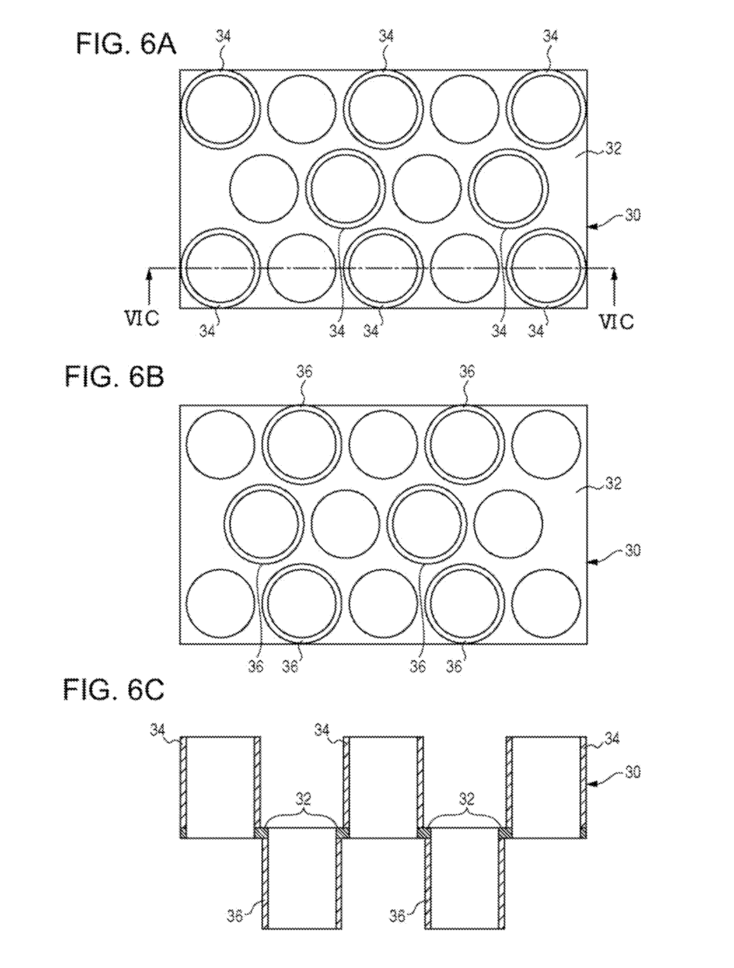

FIG. 5 is a perspective view showing the outward appearance of battery module 10 in accordance with a second exemplary embodiment. FIG. 6(A) is a plan view of a storage unit used in the second exemplary embodiment. FIG. 6(B) is a bottom view of the storage unit used in the second exemplary embodiment. FIG. 6(C) is a sectional view taken along line A-A of FIG. 6(A).

In the first exemplary embodiment, frame sections are arranged in a grid shape. However, the aspect of the arrangement of the frame sections is not limited to the grid shape. In the second exemplary embodiment, first frame sections 34 and second frame sections 36 are arranged in the closest packed state (also called staggered arrangement). In other words, in a line adjacent to a certain line in which frame sections are arranged in the lateral direction of the page having FIG. 6(A), frame sections are arranged while being shifted from the frame sections in the certain line by a half of the distance between the center positions of adjacent frame sections.

In the present exemplary embodiment, similarly to the first exemplary embodiment, the heat radiation property of a plurality of batteries 20 stored in storage unit 30 can be improved. Furthermore, at least in a line adjacent to a certain line in which frame sections are arranged in the lateral direction of the page having FIG. 6(A), an effect of suppressing the sequential abnormal heat generation of the batteries can be produced similarly to the first exemplary embodiment.

The present invention is not limited to the above-mentioned exemplary embodiments. Modifications such as various design changes can be added to the exemplary embodiments on the basis of the knowledge of the persons skilled in the art. An exemplary embodiment having undergone such modifications is also included in the scope of the present invention.

The invention related to the above-mentioned exemplary embodiments may be specified with the following items.

### (Item 1)

A battery module includes a plurality of batteries, and a storage unit that stores the plurality of batteries and is made of a thermally conductive material. The storage unit includes: a plate-like base section; hollow first frame sections that protrude on one main surface side of the base section and into which the batteries can be inserted from the other main surface side of the base section; and hollow second frame sections that are disposed adjacently to the first frame sections and protrude on the other main surface side of the base section, and into which the batteries can be inserted from the one main surface side of the base section. Each battery includes a region covered with each first frame section or each second frame section, and a region exposed to the outside.

### (Item 2)

The battery module according to item 1 in which the first frame sections and the second frame sections are arranged in a grid shape.

### (Item 3)

The battery module according to item 1 in which the first frame sections and the second frame sections are arranged in the closest packed state.

### (Item 4)

The battery module according to one of items 1 to 3 that includes heat insulation layers between the first frame sections and the batteries and between the second frame sections and the batteries.

### (Item 5)

The battery module according to one of items 1 to 4 in which, in the axial direction of each battery, the length of the region covered with each first frame section or each second frame section is equivalent to the length of the region of the battery that is exposed to the outside.

### REFERENCE MARKS IN THE DRAWINGS

10 battery module

20 battery

30 storage unit

32 base section

34 first frame section

36 second frame section

1. A battery module comprising:
a plurality of batteries; and
a storage unit for storing the plurality of batteries, the storage unit being made of a thermally conductive material,
wherein the storage unit includes:
a plate-like base section;
hollow first frame sections protruding on a first main surface side of the base section, the batteries capable of being inserted into the first frame sections from a second main surface side of the base section; and
hollow second frame sections disposed adjacently to the first frame sections and protruding on the second main surface side of the base section, the batteries capable of being inserted into the second frame sections from the first main surface side of the base section, and
wherein each of the batteries includes a region covered with each of the first frame sections or each of the second frame sections, and a region exposed to an outside.

2. The battery module according to claim 1, wherein
the first frame sections and the second frame sections are arranged in a grid shape.

3. The battery module according to claim 1, wherein
the first frame sections and the second frame sections are arranged in a closest packed state.

4. The battery module according to claim 1, comprising
heat insulation layers between the first frame sections and the batteries and between the second frame sections and the batteries.

5. The battery module according to claim 1, wherein
in an axial direction of each of the batteries, a length of the region covered with each of the first frame sections or each of the second frame sections is equivalent to a length of the region of each of the batteries that is exposed to the outside.
